(19) United States
(12) Patent Application Publication
(10) Pub. No.: US 2010/0002847 A1
(43) Pub. Date: Jan. 7, 2010

(54) EMERGENCY WARNING APPARATUS USING RELAY DRIVING BY ELECTRIC CUTTING AND BREAKDOWN

(76) Inventor: Sang Seong Han, Gongju-Si (KR)

Correspondence Address: IPLA P.A., 3580 WILSHIRE BLVD., 17TH FLOOR, LOS ANGELES, CA, 90010, US

(21) Appl. No.: 11/921,848

(22) PCT Filed: Apr. 4, 2006
(86) PCT No.: PCT/KR2006/001230

§ 371 Date: Apr. 21, 2009

(30) Foreign Application Priority Data
Jun. 10, 2005 (KR) 10-2005-0049891

(51) Int. Cl. H04M 11/04

(52) U.S. Cl. 379/40; 455/404.1

(57) ABSTRACT

The purpose of the present invention is to provide an emergency warning apparatus that notifies the user via a wired/wireless interface network of power disconnection and breakdown or fire and crack when one or more of these problems occur in a facility or equipment in which the subject apparatus is installed. Its primary objective is to enable the user/operator to eliminate the cause behind the warning and minimize the secondary damage following those problems.

### TECHNICAL FIELD

The present invention concerns an emergency warning apparatus on a relay drive operated by electric disconnection and breakdown. In particular, the present invention is that of an emergency warning apparatus on a relay drive that notifies the user of imminent danger of fire or a crack in a facility or a equipment via a wired/wireless interface network when the power supply to those facilities and equipments is stopped due to an electric disconnection or breakdown.

### BACKGROUND ART

The present invention concerns an emergency warning apparatus on a relay drive operated by electric disconnection and breakdown. In particular, the present invention is that of an emergency warning apparatus on a relay drive that notifies the user of imminent danger of fire or a crack in a facility or a equipment via a wired/wireless interface network when the power supply to those facilities and equipments is stopped due to an electric disconnection or breakdown.

In general, sensors are used to detect and notify persons around of fire or cracks found in a facility or a equipment. However, sensors are unfit to recognize these problems of facilities or equipments at an early phase, thereby not preventing the secondary damage. Also, many facilities and equipments require installations of multiple sensors to ensure complete accuracy in detection and notification by those sensors, which is another factor that contributes to the rising costs of maintaining facilities and equipments.

Moreover, because the range of detection by those sensors and traditional types of warning devices in facilities and equipments is limited to only the surroundings of the subject facilities and equipments, the user is required to remain nearby those facilities and equipments in order to determine the content and cause of those warnings.

### DISCLOSURE OF THE INVENTION

The purpose of the present invention is to provide an emergency warning apparatus that notifies the user via a wired/wireless interface network of power disconnection and breakdown or fire and crack when one or more of these problems occur in a facility or equipment in which the subject apparatus is installed. Its primary objective is to enable the user/operator to eliminate the cause behind the warning and minimize the secondary damage following those problems.

The emergency warning apparatus of the present invention has an advantage in that it notifies the user via a wired/wireless interface network of power disconnection and breakdown or fire and crack when one or more of these problems occur in a facility or equipment in which the subject apparatus is installed. It enables the user/operator to eliminate the cause behind the warning and minimize the secondary damage following those problems.

Although this article describes specific examples of executing the apparatus of the present invention in the following paragraphs, it is certain that modifications and applications of this apparatus are always probable, and that such modifications and applications therefore must fall under the scope of this patent application.

### BRIEF DESCRIPTION OF THE DRAWINGS

FIGS. 1 to 3 illustrate various examples of executing the emergency warning apparatus of the present invention that runs on a relay drive operated by electric disconnection and breakdown.

### DESCRIPTIONS OF SYMBOLS FOR MAIN PARTS OF THE DRAWINGS

| | |
|---|---|
| 1: | Relay |
| 2: | Operational Rod |
| 3, 8: | Telephone |
| 4: | Automatic Dial |
| 5: | Automatic Dial Circuit |
| 6: | Telephone Circuit |
| 7: | Wired/Wireless Interface Network |
| 9: | Memory |
| 10, 13: | Problem Detecting Means |
| 11: | Installation Surface |
| 12a, b: | Ends |
| 14: | Fixed Frame |
| 15a, b: | Springs |
| 16: | Cut Wire |
| 17: | Nylon Ribbon |
| 18a: | Outlet |
| 18b: | Plug |

### BEST MODES OF CARRYING OUT THE INVENTION

The emergency warning apparatus of the present invention that runs on a relay driven by electric disconnection or breakdown blocks the electric current from the power source when the power supply lines that deliver electricity to facilities and equipments have been cut. At the same time, depending on the potential energy conversion by the relay and its operational rod, the apparatus automatically dials the preset telephone number to notify the user who has a telephone with the preset number of the errors in the facility or equipment.

In addition to the telephone, the apparatus of the present invention also has a switch linked to the said relay operational rod. The said switch must be connected in the way that it controls the emergency power source for facilities and equipments in which the apparatus is to be installed.

The emergency warning apparatus of the present invention also consists of a device that detects cracks, shape modifications, and fire in the facility or equipment in which the apparatus is installed; and a system that blocks the electric current from the power source when the power supply lines that deliver electricity to facilities and equipments have been cut. At the same time, depending on the potential energy conversion by the relay and its operational rod, the apparatus automatically dials the preset telephone number to notify the user who has a telephone with the preset number of the errors in the facility or equipment.

The said detector, which is activated by overlapping the ends of the electric line connected to the said relay's point of contact by means of a short circuit, should be installed in a way that the overlapping part is electronically disconnected when a crack or impact occurs in the facility or equipment.

In addition, the said detector should have a spring whose one end is electronically connected to the relay's point of contact at either end of the fixing frame made of plastic, and whose the other end is connected in parallel to a nylon ribbon with a great degree of tension and attraction and susceptibility to heat and a cut wire that is electronically cut due to weak tension and attraction.

The said cut wire should have a plug and a corresponding outlet that are separated even by a small force of tension and attraction.

The said relay operational rod should be installed near the automatic dial that operates the automatic dial circuit of the aforementioned telephone. When the power source is down or power supply line is cut, the dial must be operated automatically.

The said switch linked to the relay operational rod must be connected to the automatic dial in parallel to control the automatic dial circuit.

The telephone circuit should be installed in the way that it sends a recorded voice message or a text message to the pre-designated user's telephone via a wired/wireless interface network when the power source has shut down or the power supply line has been cut.

The said voice or text message should be pre-recorded in the memory linked to the aforementioned telephone circuit.

Also, the pre-designated user's phone should be either a wired telephone or a mobile cellular phone to receive the signal from the telephone of the apparatus.

The present invention is described in detail in the following paragraphs.

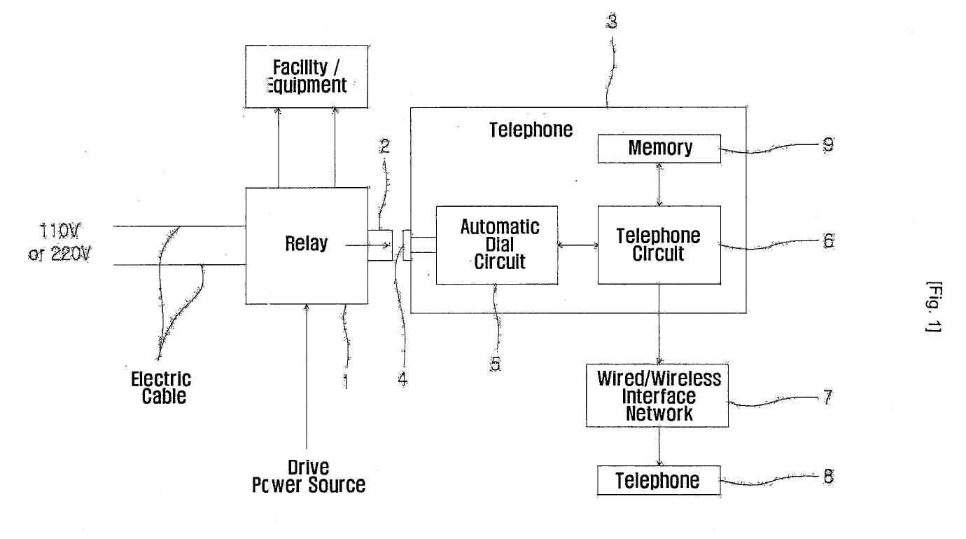

FIG. 1 shows how the apparatus of the present invention can be installed in such facilities and equipments as farms, ranches, fisheries, and aquariums and used with a standing power source that supplies power of 110V or 220V via a relay (1).

Here, the relay (1) is installed to control the standing power source that generates and supplies power of 110V or 220V to the corresponding facility or equipment. It starts operation in times of disconnection or breakdown to stop power supply to the facility or equipment and maintains the state until an external power source is installed regardless of the state of the standing power source. The relay (1) has a potential energy transformation by which the operational rod (2), a component of the relay (1) moves in one direction when the power source shuts down or the power supply line cut. The transformation in the potential energy of the operation rod (2) of the relay (1) serves as a source to notify the user of errors or faults in the facility or equipment. In other words, it is the potential energy of the operational rod (2) that automatically dials the pre-designated telephone or cellular phone.

Because the apparatus of the present invention has the operational rod (2) installed nearby the automatic dial (4) of the telephone (3), the rod (2) automatically operates the automatic dial (4) on the phone (3) when the relay (1) is activated due to an electric disconnection or breakdown in the power source. The user's phone number which is automatically dialed by the automatic dial circuit (5) is the number of the last person the user has contacted using the apparatus telephone (3) or a pre-designated number by the user.

Although the aforementioned example describes only how the operational rod (2) of the relay (1) mechanically operates the automatic dial (4), the application of the present invention is not limited to that. By installing a separate switch connected to the automatic dial (4) in parallel, and having it to turn on and off in linkage to the potential energy transformation of the operational rod (2), the same effect of using the automatic dial (4) function will be achieved.

Of course, the potential energy of the operational rod (2) can be detected using a separate sensor, such as a photo coupler.

The automatic dial circuit (5) operated by the aforementioned automatic dial (4) links the user's telephone (8) and the telephone (3) installed along with the apparatus in a facility or equipment that are far from each other via a wired/wireless interface network (7) by automatically dialing the user's telephone number when the standing power source has shut down or the power supply line has been cut.

With the phones (3, 8) in two different places linked to each other by means of automatic dialing, the telephone circuit (6) of the phone (3) sends out the message to the user's telephone (8), notifying of an error or problem in the facility or equipment. The message sent out to the user's telephone (8) is in the form of either a text message or voice message that the user has recorded in the memory (9) of the telephone (3) prior to the incident.

Therefore, the user does not have to remain in the facility or equipment, such as farms, ranches, fisheries, and aquariums that require energy for operation to know what is going on in these facilities or equipments. Furthermore, the apparatus also allows the user to minimize the secondary damage by blocking the standing power source and giving the user an early notice.

Moreover, although it has not been depicted in the drawings enclosed herein, the present invention can have a separate switch linked to the operation rod (2) of the relay, which is installed in a way to control the emergency power source that supplies energy to the facility or equipment.

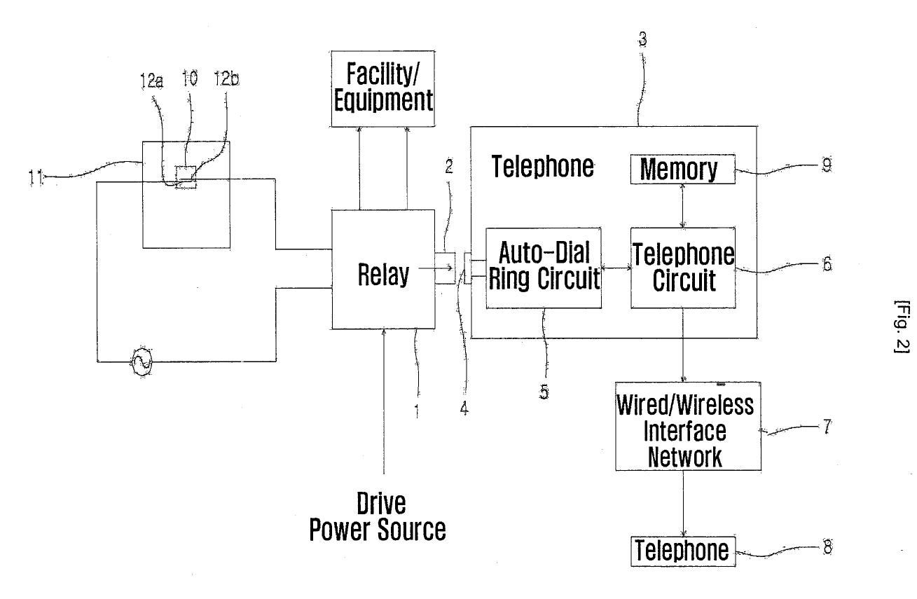

FIG. 2 illustrates another example of using the apparatus of the present invention, in cases of shape modifications and cracks in structures such as bridges, buildings, facilities, and vehicles. The power is supplied to these structures via a detector and a relay (1) installed in the power source line.

In this type of usage, the power source line with separate power sources on the points of contact with the relay (1) is connected. The ends of the line (12a, 12b) are combined to overlap each other in order to form a detector (10) that is easily separated even by minor cracks or shape modifications.

The detector (10) is installed on the walls of a building, a bridge, and other structures that carry a risk of cracking or a vehicle which may be subject to shape change due to an impact in order to detect the crack or shape change due to an impact in those facilities and equipments.

The number of detectors (10) may change depending on the area or importance of the surface (11) onto which the detectors are to be attached. Such flexibility in installation ensures accuracy in detecting cracks and shape changes in bridges, buildings, structures, and vehicles in which the apparatuses are installed.

The operation of the relay (1) and the telephone (3) installed to detect cracks or impact-caused shape changes in the aforementioned structures takes place in the same way as in the example of FIG. 1. This apparatus may come in handy especially in cases of car accidents in uninhabited places. Here, the location of the telephone (3) of the apparatus installed in the car can be found by satellite search, ensuring more immediate and accurate post-accident dealings. In this case, the telephone (3) in question must be a cellular phone that can be located by satellite search and communicate wirelessly.

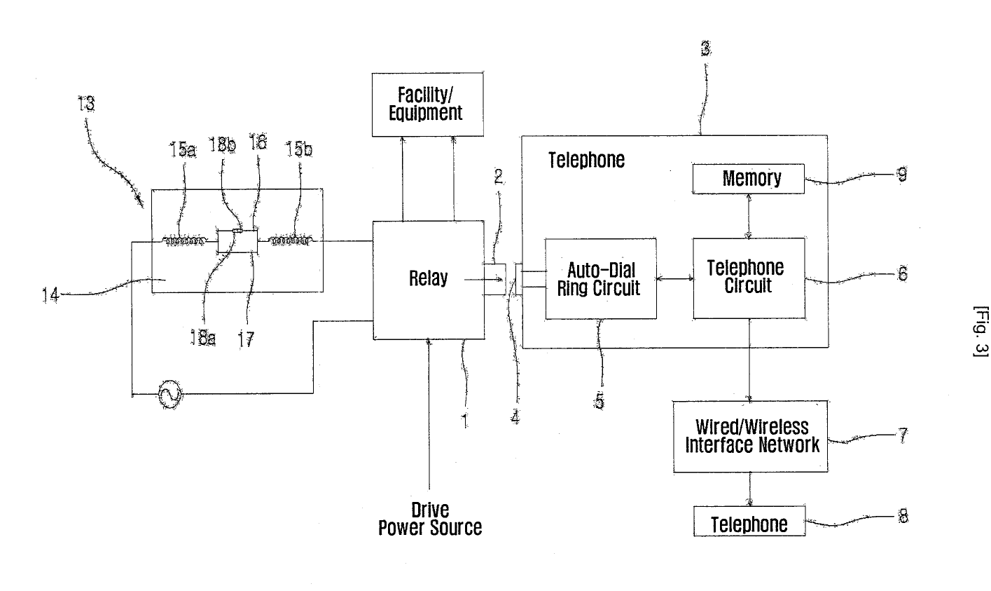

FIG. 3 shows an example of using the apparatus of the present invention in fire-fighting. Once the detector (13) located on the power source line connected to the point of contact with the relay (1) is activated by a fire, the telephone (3), as explained in FIGS. 1 and 2, is activated to notify the user of the fire. In this case, the detectors (13) should be installed in various places where fire is likely to reach as in the case of FIG. 2. Those detectors (13) must be linked to one another.

The aforementioned detectors (13) react to the fire and high temperature generated thereby. Each of the said detector (13) should have springs (15a, 15b) whose one end is electronically connected to the relay's point of contact at either end of the fixing frame (14) made of plastic, and whose the other end is connected in parallel to a nylon ribbon (17) with a great degree of tension and attraction and susceptibility to heat and a cut wire (16) that is electronically cut due to weak tension and attraction.

Here, the cut wire (16) should have a plug (18b) that is electronically connected to, and separated by weak tension and attraction from an outlet (18a).

The nylon ribbon (17) susceptible to the heat is lost, exerting strong tension and attraction on both ends of the cut wire (16) by means of the springs (15a, 15b). The relay (1) and the telephone (3) linked to these are activated to notify of the fire.

All these examples of usage mean that the apparatus of the present invention can be installed at fire stations, police stations, and other observatory systems for public security to take measures against errors and faults found in various facilities and equipments that may lead to hazardous situations.

1. An emergency warning apparatus with a relay blocks the electric current from the power source when the power source shuts down or the power supply line is cut, while also transforming the potential energy of its operational rod; and a telephone that automatically dials the pre-designated telephone number as the potential energy of the aforementioned relay's operational rod changes to deliver a message notifying of the error.

2. In claim [1], an emergency warning apparatus with a switch linked to the said relay operational rod. The said switch must be connected in the way that it controls the emergency power source for facilities and equipments in which the apparatus is to be installed.

3. An emergency warning apparatus with a device that detects cracks, shape modifications, and fire in the facility or equipment in which the apparatus is installed; a relay blocks the electric current from the power source when the power source shuts down or the power supply line is cut, while also transforming the potential energy of its operational rod; and a telephone that automatically dials the pre-designated telephone number as the potential energy of the aforementioned relay's operational rod changes to deliver a message notifying of the error.

4. In claim [3], the said detector, which is activated by overlapping the ends of the electric line connected to the said relay's point of contact by means of a short circuit, should be installed in a way that the overlapping part is electronically disconnected when a crack or impact occurs in the facility or equipment.

5. In claim [3], the said detector should have a spring whose one end is electronically connected to the relay's point of contact at either end of the fixing frame made of plastic, and whose the other end is connected in parallel to a nylon ribbon with a great degree of tension and attraction and susceptibility to heat and a cut wire that is electronically cut due to weak tension and attraction.

6. In claim [5], the said cut wire should have a plug and a corresponding outlet that are separated even by a small force of tension and attraction.

7. In claims [1] and [3], the said relay operational rod should be installed near the automatic dial that operates the automatic dial circuit of the aforementioned telephone. When the power source is down or the power supply line is cut, the dial must be operated automatically.

8. In claims [1] and [3], the said switch linked to the relay operational rod must be connected to the automatic dial in parallel to control the automatic dial circuit.

9. In claims [1] and [3], the telephone circuit should be installed in the way that it sends a recorded voice message or a text message to the pre-designated user's telephone via a wired/wireless interface network when the power source has shut down or the power supply line has been cut.

10. In claim [9], the said voice or text message should be pre-recorded in the memory linked to the aforementioned telephone circuit.

11. In claims [1] and [3], the pre-designated user's phone should be either a wired telephone or a mobile cellular phone to receive the signal from the telephone of the apparatus.
